(19) United States
(12) Patent Application Publication
(10) Pub. No.: US 2020/0288502 A1
(43) Pub. Date: Sep. 10, 2020

(54) METHOD FOR PERFORMING A RANDOM ACCESS PROCEDURE IN BANDWIDTH PART (BWP) OPERATION IN WIRELESS COMMUNICATION SYSTEM AND A DEVICE THEREFOR

(71) Applicant: LG ELECTRONICS INC., Seoul (KR)

(72) Inventors: Eunjong LEE, Seoul (KR); Sunyoung LEE, Seoul (KR)

(73) Assignee: LG ELECTRONICS INC., Seoul (KR)

(21) Appl. No.: 16/652,981

(22) PCT Filed: Oct. 23, 2018
(86) PCT No.: PCT/KR2018/012536

§ 371 Date: Apr. 1, 2020

Related U.S. Application Data
(60) Provisional application No. 62/577,719, filed on Oct. 27, 2017.

(51) Int. Cl. H04W 74/08; H04L 5/00; H04W 24/08; H04W 72/04

(52) U.S. Cl. CPC H04W 74/0833; H04W 74/0891; H04L 5/0098; H04W 24/08; H04W 72/042; H04L 5/0092

(57) ABSTRACT

The present invention relates to a wireless communication system. More specifically, the present invention relates to a method and a device for performing a random access procedure in BWP operation in wireless communication system, the method comprising: starting a timer related to timing alignment of a Timing Advance Group (TAG) to which a serving cell belongs; switching an active Downlink (DL) Bandwidth Part (BWP) of the serving cell from a first DL BWP to a second DL BWP, when the timer expires; and monitoring a downlink control channel on the second DL BWP. The device is capable of communicating with at least one of another UE, a UE related to an autonomous driving vehicle, a base station or a network.

### TECHNICAL FIELD

The present invention relates to a wireless communication system and, more particularly, to a method for performing a random access procedure in bandwidth part (BWP) operation in wireless communication system and a device therefor.

### BACKGROUND ART

As an example of a mobile communication system to which the present invention is applicable, a 3rd Generation Partnership Project Long Term Evolution (hereinafter, referred to as LTE) communication system is described in brief.

FIG. 1 is a view schematically illustrating a network structure of an E-UMTS as an exemplary radio communication system. An Evolved Universal Mobile Telecommunications System (E-UMTS) is an advanced version of a conventional Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARQ)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

Although wireless communication technology has been developed to LTE based on wideband code division multiple access (WCDMA), the demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

As more and more communication devices demand larger communication capacity, there is a need for improved mobile broadband communication compared to existing RAT. Also, massive machine type communication (MTC), which provides various services by connecting many devices and objects, is one of the major issues to be considered in the next generation communication (NR, New Radio). In addition, a communication system design considering a service/UE sensitive to reliability and latency is being discussed. The introduction of next-generation RAT, which takes into account such Enhanced Mobile BroadBand (eMBB) transmission, and ultra-reliable and low latency communication (URLLC) transmission, is being discussed.

### DISCLOSURE

### Technical Problem

An object of the present invention devised to solve the problem lies in a method and device for performing a random access procedure in bandwidth part (BWP) operation in wireless communication system.

In the currently agreement, the UE can perform Random Access (RACH) procedure on an active UL/DL BWP, if PRACH resource is configured on the active UL BWP. Otherwise the UE performs the RACH procedure on the initial DL/UL BWP after autonomous BWP switching. In the former case, the UE can stop the BWP inactivity timer when initiating the Random Access (RACH) procedure, but the network would continue the BWP inactivity timer of the UE because it doesn't know when the UE initiates the contention based RA (CBRA) procedure. There is the issue that the network may transmit the DL data on the initial/default DL BWP if the BWP inactivity timer for the UE of the network expires while the UE is performing the CBRA procedure. In the latter case, there is the issue that the network may transmit the DL data on the active DL BWP because it is not aware when the UE would switch to the initial DL/UL BWP. In both cases, it is raised the issue that the autonomous BWP switching can cause the DL data loss because the network is not aware when the UE would perform the CBRA procedure. For contention based RA (CBRA) procedure, the network cannot anticipate when the UE performs the RA procedure or the autonomous BWP switching. It will be certainly occurred the DL data loss if the network transmits a DL data or PDCCH order while the UE is performing CBRA procedure after BWP switching. If the RACH procedure continuously fails until the maximum number of preamble transmission is reached, the possibility of DL data loss becomes greater.

According to the current specification, the network can expect the UE to perform CBRA procedure after pTAT expires. There is no need to keep the UE in a BWP without PRACH resource after pTAT expiry because it is clear that the UE is going to perform RA procedure by switching to initial DL/UL BWP and DL data loss may occur.

The technical problems solved by the present invention are not limited to the above technical problems and those skilled in the art may understand other technical problems from the following description.

### Technical Solution

The object of the present invention can be achieved by providing a method for User Equipment (UE) operating in a wireless communication system as set forth in the appended claims.

In another aspect of the present invention, provided herein is a communication apparatus as set forth in the appended claims.

It is to be understood that both the foregoing general description and the following detailed description of the present invention are exemplary and explanatory and are intended to provide further explanation of the invention as claimed.

### Advantageous Effects

According to the proposed invention, loss of DL data received from the network can be reduced by switching the active BWP to the default BWP or the initial BWP when the Time Alignment Timer (TAT) expires.

Furthermore, in the contention based RA (CBRA) procedure performed at the expiration of the TAT, a successful CBRA procedure is possible since the network can know the DL BWP to transmit RAR.

It will be appreciated by persons skilled in the art that the effects achieved by the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a diagram showing a network structure of an Evolved Universal Mobile Telecommunications System (E-UMTS) as an example of a wireless communication system;

FIG. 2a is a block diagram illustrating network structure of an evolved universal mobile telecommunication system (E-UMTS), and FIG. 2b is a block diagram depicting architecture of a typical E-UTRAN and a typical EPC;

FIG. 3 is a diagram showing a control plane and a user plane of a radio interface protocol between a UE and an E-UTRAN based on a 3rd generation partnership project (3GPP) radio access network standard;

FIG. 4a is a block diagram illustrating network structure of NG Radio Access Network (NG-RAN) architecture, and FIG. 4b is a block diagram depicting architecture of functional Split between NG-RAN and 5G Core Network (5GC);

FIG. 5 is a diagram showing a control plane and a user plane of a radio interface protocol between a UE and a NG-RAN based on a 3rd generation partnership project (3GPP) radio access network standard;

FIG. 6 is a block diagram of a communication apparatus according to an embodiment of the present invention;

FIG. 7 is an example of BWP operation in the prior art;

FIG. 8 is a conceptual diagram for performing a random access procedure in BWP operation by a user equipment in wireless communication system according to embodiments of the present invention;

FIGS. 9 to 11 are examples for performing a random access procedure in BWP operation in wireless communication system according to embodiments of the present invention; and

FIG. 12 is a conceptual diagram for performing a random access procedure in BWP operation by a base station in wireless communication system according to embodiments of the present invention

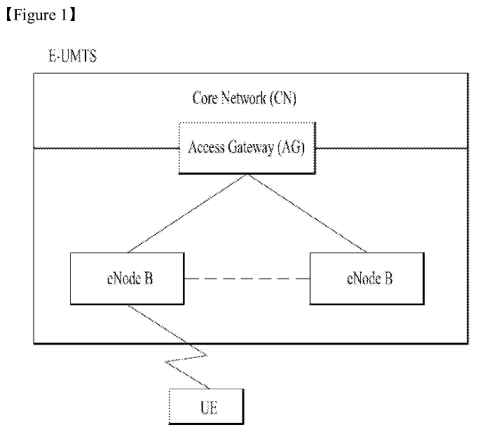

### BEST MODE

Universal mobile telecommunications system (UMTS) is a 3rd Generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3G LTE requires reduced cost per bit, increased service availability, flexible use of a frequency band, a simple structure, an open interface, and adequate power consumption of a terminal as an upper-level requirement.

Hereinafter, structures, operations, and other features of the present invention will be readily understood from the embodiments of the present invention, examples of which are illustrated in the accompanying drawings. Embodiments described later are examples in which technical features of the present invention are applied to a 3GPP system.

Although the embodiments of the present invention are described using a long term evolution (LTE) system and a LTE-advanced (LTE-A) system in the present specification, they are purely exemplary. Therefore, the embodiments of the present invention are applicable to any other communication system corresponding to the above definition. In addition, although the embodiments of the present invention are described based on a frequency division duplex (FDD) scheme in the present specification, the embodiments of the present invention may be easily modified and applied to a half-duplex FDD (H-FDD) scheme or a time division duplex (TDD) scheme.

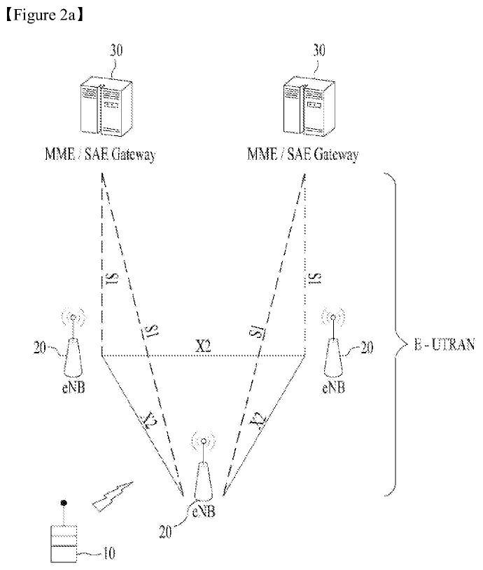

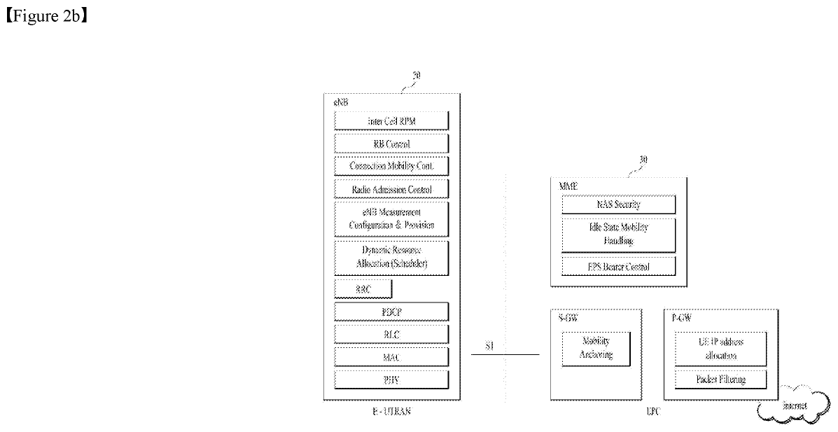

FIG. 2a is a block diagram illustrating network structure of an evolved universal mobile telecommunication system (E-UMTS). The E-UMTS may be also referred to as an LTE system. The communication network is widely deployed to provide a variety of communication services such as voice (VoIP) through IMS and packet data.

As illustrated in FIG. 2a, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from eNodeB 20 to UE 10, and “uplink” refers to communication from the UE to an eNodeB. UE 10 refers to communication equipment carried by a user and may be also referred to as a mobile station (MS), a user terminal (UT), a subscriber station (SS) or a wireless device.

FIG. 2b is a block diagram depicting architecture of a typical E-UTRAN and a typical EPC.

As illustrated in FIG. 2B, an eNodeB 20 provides end points of a user plane and a control plane to the UE 10. MME/SAE gateway 30 provides an end point of a session and mobility management function for UE 10. The eNodeB and MME/SAE gateway may be connected via an S1 interface.

The eNodeB 20 is generally a fixed station that communicates with a UE 10, and may also be referred to as a base station (BS) or an access point. One eNodeB 20 may be deployed per cell. An interface for transmitting user traffic or control traffic may be used between eNodeBs 20.

The MME provides various functions including NAS signaling to eNodeBs 20, NAS signaling security, AS Security control, Inter CN node signaling for mobility between 3GPP access networks, Idle mode UE Reachability (including control and execution of paging retransmission), Tracking Area list management (for UE in idle and active mode), PDN GW and Serving GW selection, MME selection for handovers with MME change, SGSN selection for handovers to 2G or 3G 3GPP access networks, Roaming, Authentication, Bearer management functions including dedicated bearer establishment, Support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity includes both an MME and an SAE gateway.

A plurality of nodes may be connected between eNodeB 20 and gateway 30 via the S1 interface. The eNodeBs 20 may be connected to each other via an X2 interface and neighboring eNodeBs may have a meshed network structure that has the X2 interface.

As illustrated, eNodeB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNodeB measurements, radio bearer control, radio admission control (RAC), and connection mobility control in LTE ACTIVE state. In the EPC, and as noted above, gateway 30 may perform functions of paging origination, LTE-IDLE state management, ciphering of the user plane, System Architecture Evolution (SAE) bearer control, and ciphering and integrity protection of Non-Access Stratum (NAS) signaling. The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

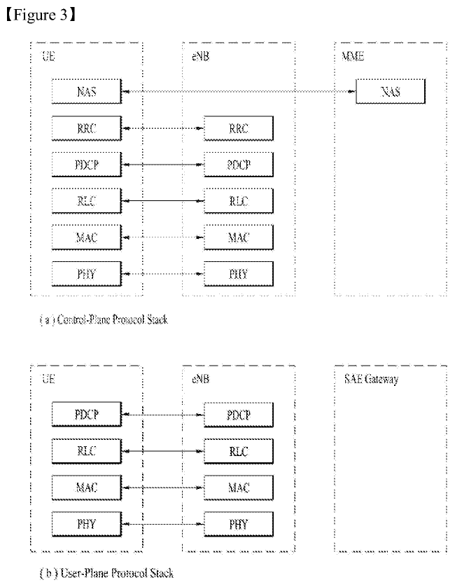

FIG. 3 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

A physical (PHY) layer of a first layer provides an information transfer service to a higher layer using a physical channel. The PHY layer is connected to a medium access control (MAC) layer located on the higher layer via a transport channel. Data is transported between the MAC layer and the PHY layer via the transport channel. Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

The MAC layer of a second layer provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

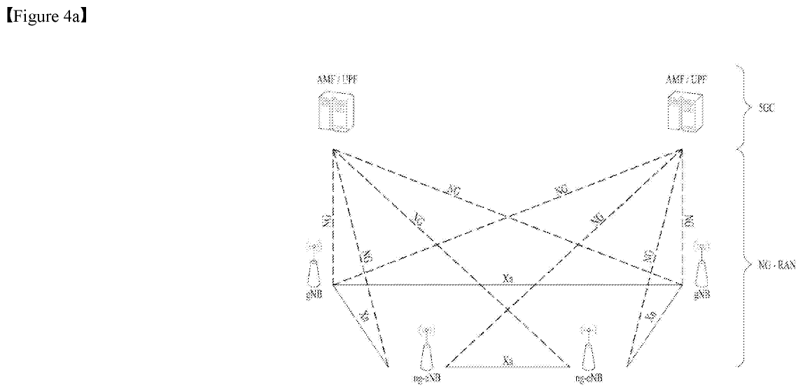

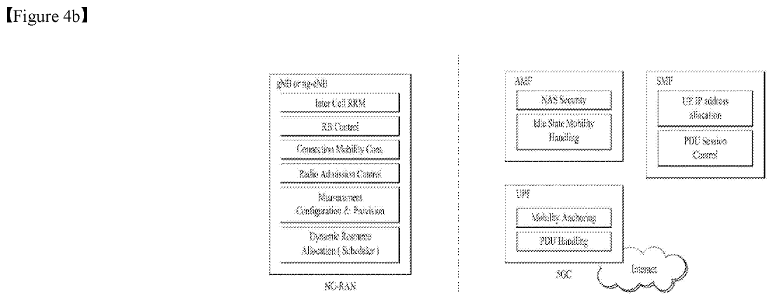

FIG. 4a is a block diagram illustrating network structure of NG Radio Access Network (NG-RAN) architecture, and FIG. 4b is a block diagram depicting architecture of functional Split between NG-RAN and 5G Core Network (5GC).

An NG-RAN node is a gNB, providing NR user plane and control plane protocol terminations towards the UE, or an ng-eNB, providing E-UTRA user plane and control plane protocol terminations towards the UE.

The gNBs and ng-eNBs are interconnected with each other by means of the Xn interface. The gNBs and ng-eNBs are also connected by means of the NG interfaces to the 5GC, more specifically to the AMF (Access and Mobility Management Function) by means of the NG-C interface and to the UPF (User Plane Function) by means of the NG-U interface.

The Xn Interface includes Xn user plane (Xn-U), and Xn control plane (Xn-C). The Xn User plane (Xn-U) interface is defined between two NG-RAN nodes. The transport network layer is built on IP transport and GTP-U is used on top of UDP/IP to carry the user plane PDUs. Xn-U provides non-guaranteed delivery of user plane PDUs and supports the following functions: i) Data forwarding, and ii) Flow control. The Xn control plane interface (Xn-C) is defined between two NG-RAN nodes. The transport network layer is built on SCTP on top of IP. The application layer signalling protocol is referred to as XnAP (Xn Application Protocol). The SCTP layer provides the guaranteed delivery of application layer messages. In the transport IP layer point-to-point transmission is used to deliver the signalling PDUs. The Xn-C interface supports the following functions: i) Xn interface management, ii) UE mobility management, including context transfer and RAN paging, and iii) Dual connectivity.

The NG Interface includes NG User Plane (NG-U) and NG Control Plane (NG-C). The NG user plane interface (NG-U) is defined between the NG-RAN node and the UPF. The transport network layer is built on IP transport and GTP-U is used on top of UDP/IP to carry the user plane PDUs between the NG-RAN node and the UPF. NG-U provides non-guaranteed delivery of user plane PDUs between the NG-RAN node and the UPF.

The NG control plane interface (NG-C) is defined between the NG-RAN node and the AMF. The transport network layer is built on IP transport. For the reliable transport of signalling messages, SCTP is added on top of IP. The application layer signalling protocol is referred to as NGAP (NG Application Protocol). The SCTP layer provides guaranteed delivery of application layer messages. In the transport, IP layer point-to-point transmission is used to deliver the signalling PDUs.

NG-C provides the following functions: i) NG interface management, ii) UE context management, iii) UE mobility management, iv) Configuration Transfer, and v) Warning Message Transmission.

The gNB and ng-eNB host the following functions: i) Functions for Radio Resource Management: Radio Bearer Control, Radio Admission Control, Connection Mobility Control, Dynamic allocation of resources to UEs in both uplink and downlink (scheduling), ii) IP header compression, encryption and integrity protection of data, iii) Selection of an AMF at UE attachment when no routing to an AMF can be determined from the information provided by the UE, iv) Routing of User Plane data towards UPF(s), v) Routing of Control Plane information towards AMF, vi) Connection setup and release, vii) Scheduling and transmission of paging messages (originated from the AMF), viii) Scheduling and transmission of system broadcast information (originated from the AMF or O&M), ix) Measurement and measurement reporting configuration for mobility and scheduling, x) Transport level packet marking in the uplink, xi) Session Management, xii) Support of Network Slicing, and xiii) QoS Flow management and mapping to data radio bearers. The Access and Mobility Management Function (AMF) hosts the following main functions: i) NAS signalling termination, ii) NAS signalling security, iii) AS Security control, iv) Inter CN node signalling for mobility between 3GPP access networks, v) Idle mode UE Reachability (including control and execution of paging retransmission), vi) Registration Area management, vii) Support of intra-system and inter-system mobility, viii) Access Authentication, ix) Mobility management control (subscription and policies), x) Support of Network Slicing, and xi) SMF selection.

The User Plane Function (UPF) hosts the following main functions: i) Anchor point for Intra-/Inter-RAT mobility (when applicable), ii) External PDU session point of interconnect to Data Network, iii) Packet inspection and User plane part of Policy rule enforcement, iv) Traffic usage reporting, v) Uplink classifier to support routing traffic flows to a data network, vi) QoS handling for user plane, e.g. packet filtering, gating, UL/DL rate enforcement, and vii) Uplink Traffic verification (SDF to QoS flow mapping).

The Session Management function (SMF) hosts the following main functions: i) Session Management, ii) UE IP address allocation and management, iii) Selection and control of UP function, iv) Configures traffic steering at UPF to route traffic to proper destination, v) Control part of policy enforcement and QoS, vi) Downlink Data Notification.

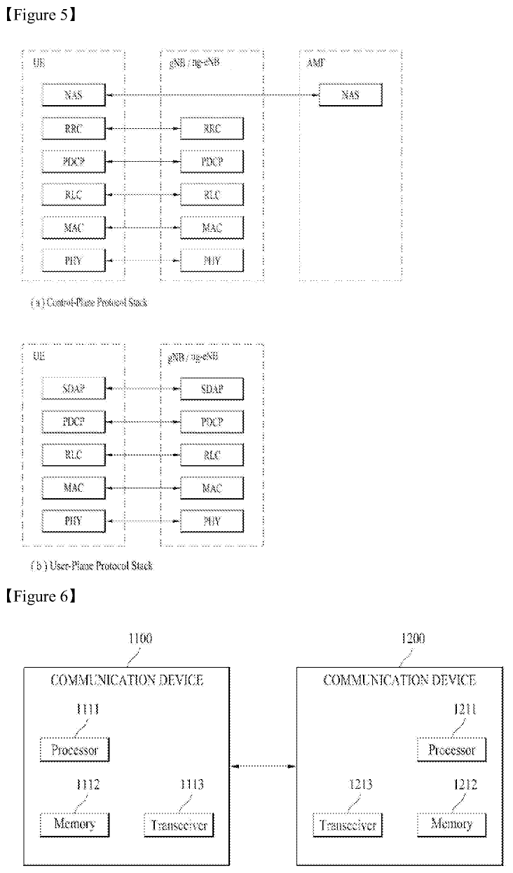

FIG. 5 is a diagram showing a control plane and a user plane of a radio interface protocol between a UE and a NG-RAN based on a 3rd generation partnership project (3GPP) radio access network standard.

The user plane protocol stack contains Phy, MAC, RLC, PDCP and SDAP (Service Data Adaptation Protocol) which is newly introduced to support 5G QoS model.

The main services and functions of SDAP entity include i) Mapping between a QoS flow and a data radio bearer, and ii) Marking QoS flow ID (QFI) in both DL and UL packets. A single protocol entity of SDAP is configured for each individual PDU session.

At the reception of an SDAP SDU from upper layer for a QoS flow, the transmitting SDAP entity may map the SDAP SDU to the default DRB if there is no stored QoS flow to DRB mapping rule for the QoS flow. If there is a stored QoS flow to DRB mapping rule for the QoS flow, the SDAP entity may map the SDAP SDU to the DRB according to the stored QoS flow to DRB mapping rule. And the SDAP entity may construct the SDAP PDU and deliver the constructed SDAP PDU to the lower layers.

FIG. 6 is a block diagram of communication devices according to an embodiment of the present invention.

The apparatus shown in FIG. 6 can be a user equipment (UE) and/or eNB or gNB adapted to perform the above mechanism, but it can be any device for performing the same operation.

As shown in FIG. 6, one of the communication device 1100 and the communication device 1200 may be a user equipment (UE) and the other one mat be a base station. Alternatively, one of the communication device 1100 and the communication device 1200 may be a UE and the other one may be another UE. Alternatively, one of the communication device 1100 and the communication device 1200 may be a network node and the other one may be another network node. In the present disclosure, the network node may be a base station (BS). In some scenarios, the network node may be a core network device (e.g. a network device with a mobility management function, a network device with a session management function, and etc.).

In some scenarios of the present disclosure, either one of the communication devices 1100, 1200, or each of the communication devices 1100, 1200 may be wireless communication device(s) configured to transmit/receive radio signals to/from an external device, or equipped with a wireless communication module to transmit/receive radio signals to/from an external device. The wireless communication module may be a transceiver. The wireless communication device is not limited to a UE or a BS, and the wireless communication device may be any suitable mobile computing device that is configured to implement one or more implementations of the present disclosure, such as a vehicular communication system or device, a wearable device, a laptop, a smartphone, and so on. A communication device which is mentioned as a UE or BS in the present disclosure may be replaced by any wireless communication device such as a vehicular communication system or device, a wearable device, a laptop, a smartphone, and so on.

In the present disclosure, communication devices 1100, 1200 include processors 1111, 1211 and memories 1112, 1212. The communication devices 1100 may further include transceivers 1113, 1213 or configured to be operatively connected to transceivers 1113, 1213.

The processor 1111 and/or 1211 implements functions, procedures, and/or methods disclosed in the present disclosure. One or more protocols may be implemented by the processor 1111 and/or 1211. For example, the processor 1111 and/or 1211 may implement one or more layers (e.g., functional layers). The processor 1111 and/or 1211 may generate protocol data units (PDUs) and/or service data units (SDUs) according to functions, procedures, and/or methods disclosed in the present disclosure. The processor 1111 and/or 1211 may generate messages or information according to functions, procedures, and/or methods disclosed in the present disclosure. The processor 1111 and/or 1211 may generate signals (e.g. baseband signals) containing PDUs, SDUs, messages or information according to functions, procedures, and/or methods disclosed in the present disclosure and provide the signals to the transceiver 1113 and/or 1213 connected thereto. The processor 1111 and/or 1211 may receive signals (e.g. baseband signals) from the transceiver 1113 and/or 1213 connected thereto and obtain PDUs, SDUs, messages or information according to functions, procedures, and/or methods disclosed in the present disclosure.

The memory of 1112 and/or 1212 is connected to the processor of the network node and stores various types of PDUs, SDUs, messages, information and/or instructions. The memory 1112 and/or 1212 may be arranged inside or outside the processor 1111 and/or 1211, respectively, and may be connected the processor 1111 and/or 1211, respectively, through various techniques, such as wired or wireless connections.

The transceiver 1113 and/or 1213 is connected to the processor 1111 and/or 1211, respectively, and may be controlled by the processor 1111 and/or 1211, respectively, to transmit and/or receive a signal to/from an external device. The processor 1111 and/or 1211 may control transceiver 1113 and/or 1213, respectively, to initiate communication and to transmit or receive signals including various types of information or data which are transmitted or received through a wired interface or wireless interface. The transceivers 1113, 1213 include a receiver to receive signals from an external device and transmit signals to an external device.

In a wireless communication device such as a UE or BS, an antenna facilitates the transmission and reception of radio signals (i.e. wireless signals). In the wireless communication device, the transceiver 1113 or 1213 transmits and/or receives a wireless signal such as a radio frequency (RF) signal. For a communication device which is a wireless communication device (e.g. BS or UE), the transceiver 1113 or 1213 may be referred to as a radio frequency (RF) unit. In some implementations, the transceiver 1113 and/or 1213 may forward and convert baseband signals provided by the processor 1111 and/or 1211 connected thereto into radio signals with a radio frequency. In the wireless communication device, the transceiver 1113 or 1213 may transmit or receive radio signals containing PDUs, SDUs, messages or information according to functions, procedures, and/or methods disclosed in the present disclosure via a radio interface (e.g. time/frequency resources). In some implementations, upon receiving radio signals with a radio frequency from another communication device, the transceiver 1113 and/or 1213 may forward and convert the radio signals to baseband signals for processing by the processor 1111 and/or 1211. The radio frequency may be referred to as a carrier frequency. In a UE, the processed signals may be processed according to various techniques, such as being transformed into audible or readable information to be output via a speaker of the UE.

In some scenarios of the present disclosure, functions, procedures, and/or methods disclosed in the present disclosure may be implemented by a processing chip. The processing chip may be a system on chip (SoC). The processing chip may include the processor 1111 or 1211 and the memory 1112 or 1212, and may be mounted on, installed on, or connected to the communication device 1100 or 1200. The processing chip may be configured to perform or control any one of the methods and/or processes described herein and/or to cause such methods and/or processes to be performed by a communication device which the processing chip is mounted on, installed on, or connected to. The memory 1112 or 1212 in the processing chip may be configured to store software codes including instructions that, when executed by the processor, causes the processor to perform some or all of functions, methods or processes discussed in the present disclosure. The memory 1112 or 1212 in the processing chip may store or buffer information or data generated by the processor of the processing chip or information recovered or obtained by the processor of the processing chip. One or more processes involving transmission or reception of the information or data may be performed by the processor 1111 or 1211 of the processing chip or under control of the processor 1111 or 1211 of the processing chip. For example, a transceiver 1113 or 1213 operably connected or coupled to the processing chip may transmit or receive signals containing the information or data under the control of the processor 1111 or 1211 of the processing chip.

For a communication device which is a wireless communication device (e.g. BS or UE), the communication device may include or be equipped with a single antenna or multiple antennas. The antenna may be configured to transmit and/or receive a wireless signal to/from another wireless communication device.

For a communication device which is a UE, the communication device may further include or be equipped with a power management module, an antenna, a battery, a display, a keypad, a Global Positioning System (GPS) chip, a sensor, a memory device, a Subscriber Identification Module (SIM) card (which may be optional), a speaker and/or a microphone. The UE may include or be equipped with a single antenna or multiple antennas. A user may enter various types of information (e.g., instructional information such as a telephone number), by various techniques, such as by pushing buttons of the keypad or by voice activation using the microphone. The processor of the UE receives and processes the user's information and performs the appropriate function(s), such as dialing the telephone number. In some scenarios, data (e.g., operational data) may be retrieved from the SIM card or the memory device to perform the function(s). In some scenarios, the processor of the UE may receive and process GPS information from a GPS chip to perform functions related to a position or a location of a UE, such as vehicle navigation, a map service, and so on. In some scenarios, the processor may display these various types of information and data on the display for the user's reference and convenience. In some implementations, a sensor may be coupled to the processor of the UE. The sensor may include one or more sensing devices configured to detect various types of information including, but not limited to, speed, acceleration, light, vibration, proximity, location, image and so on. The processor of the UE may receive and process sensor information obtained from the sensor and may perform various types of functions, such as collision avoidance, autonomous driving and so on. Various components (e.g., a camera, a Universal Serial Bus (USB) port, etc.) may be further included in the UE. For example, a camera may be further coupled to the processor of the UE and may be used for various services such as autonomous driving, a vehicle safety service and so on. In some scenarios, some components, e.g., a keypad, a Global Positioning System (GPS) chip, a sensor, a speaker and/or a microphone, may not be implemented in a UE.

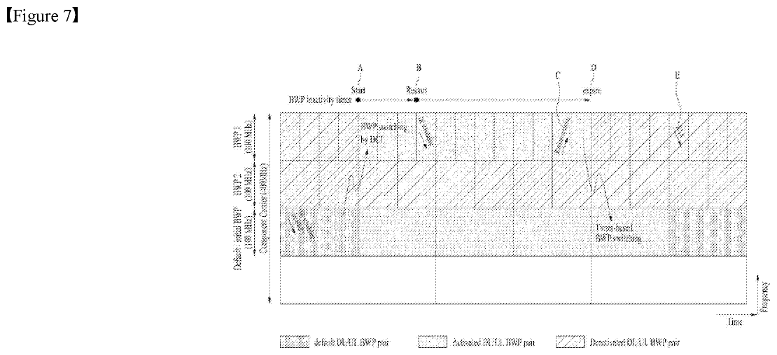

FIG. 7 is an example of BWP operation in the prior art.

It has been discussed that operating the wider bandwidth on a single carrier is more efficient than aggregating contiguous intra-band CCs with smaller bandwidth, in a state that the maximum channel bandwidth of NR is 400 MHz per carrier. In order to provide the carrier with maximum bandwidth for UEs with different RF chain capabilities, RAN1 agreed to support the aggregation of multiple sub-bands with smaller bandwidth. In this wider bandwidth operation, it assumes that one or multiple bandwidth part (BWP) configurations for each CC can be semi-statically signalled to a UE and each bandwidth part is associated with a specific numerology.

Based on the current agreement, the DL/UL BWP can be defined as follows:
Initial active DL/UL BWP: it is valid for a UE until the UE is explicitly (re)configured with bandwidth part(s) during or after RRC connection is established. As the first RRC Connection reconfiguration can be received only after the UE completes the RRC Connection establishment, it could be understood that BWP switching doesn't occur during RA procedure for RRC Connection establishment.
Default DL/UL BWP: For a PCell, the default DL BWP (or DL/UL BWP pair) can be configured/reconfigured to a UE. If no default DL BWP is configured, the default DL BWP is the initial active DL BWP. For an SCell, the default DL BWP (or DL/UL BWP pair) can be configured to a UE with a timer for timer-based active DL BWP (or DL/UL BWP pair) switching, along with a default DL BWP (or the default DL/UL BWP pair) which is used when the timer is expired. The default DL BWP for a SCell can be different from the first active DL BWP.
Active DL/UL BWP other than the default DL/UL BWP: One or multiple DL BWP(s) and UL BWP(s) (or DL/UL BWP pair(s)) can be semi-statically configured to a UE by signalling. UE expects at least one DL BWP and one UL BWP being active among the set of configured BWPs for a given time instant. A UE is only assumed to receive/transmit within active DL/UL bandwidth part(s) using the associated numerology.
DL/UL BWP pair: For unpaired spectrum, a DL BWP and an UL BWP are jointly configured as a pair, with the restriction that the DL and UL BWPs of such a DL/UL BWP pair share the same center frequency but may be of different bandwidths in Rel-15 for each UE-specific serving cell for a UE. For paired spectrum, DL and UL BWPs are configured separately and independently in Rel-15 for each UE-specific serving cell for a UE. Up to now, there was no discussion whether the paired DL/UL BWP is configured with cell-common manner or UE-specific manner. Based on the agreement, it seems that a DL BWP and an UL BWP can be jointly configured as a pair in the UE-specific manner for unpaired spectrum.

The activation/deactivation of DL and UL BWPs can be performed by means of dedicated RRC signalling, DCI or timer (i.e. BWP inactivity timer). Timer-based switching is to support a fallback mechanism to default DL BWP (or initial DL BWP). In this case, a UE starts the BWP inactivity timer when switching to a DL BWP other than the default DL BWP and restarts the BWP inactivity timer to the initial value when it successfully decodes a DCI to schedule PDSCH(s) in its active DL BWP. And, the UE switches its active DL BWP to the default DL BWP (or initial DL BWP) when the BWP inactivity timer expires. If the active DL/UL BWP has been paired, a UE will switch to default DL/UL BWP pair when the switching condition is met.

If the UE in RRC_IDLE performs an RA procedure, RAN1 agreed that the initial active BWP is valid until the UE is explicitly reconfigured during/after RRC Connection establishment. As the first RRC Connection reconfiguration can be received only after the UE completes the RRC Connection establishment, it could be understood that BWP switching doesn't occur during RA procedure for RRC Connection establishment.

However, if the UE in RRC_CONNECTED performs an RA procedure, BWP switching could occur in the case that the BWP inactivity timer for the active BWP expires while RA procedure is ongoing on an active BWP other than the default BWP. For CFRA, the network can transmit a RAR on the switched active BWP because it knows the UE is performing the RA procedure and the time when the UE switches to the default BWP. However, the problem may happen in the case of performing the CBRA procedure because the network doesn't know whether the UE is performing RA procedure or not, i.e., UE initiated an RA procedure on a PCell. If the network receives a RAP from any UEs, the network cannot decide which BWP it should transmit RAR on. Although the UE refers to the RA procedure as failure and retransmits the RAP on the default BWP, the network cannot know BWP to transmit RAR if the DL/UL BWP are configured with UE-specific manner. FIG. 7 below describes the case where the above problem can occur.

Referring to FIG. 7, when the UE switches an active DL BWP from a default BWP to BWP 1, the UE can starts a BWP inactivity timer of the BWP 1 (A). The BWP inactivity timer of the BWP 1 restarts when DL scheduling information is received (B).

After transmitting random preamble on BWP 1 (C), the UE switches an active DL BWP to the default BWP due to expiration of the BWP inactivity timer of the BWP 1 (D).

In this case, since the network cannot know that the UE switches the active DL BWP, the network transmits a random access response (RAR) on the BWP1 (E). Since the BWP1 is in a deactivate state, the UE cannot receive RAR successfully. As a result, the RACH procedure continuously fails until the maximum number of preamble transmission is reached, so the possibility of DL data loss becomes greater.

Therefore, in order to successfully perform the contention based RA procedure during wider bandwidth operation, it would be necessary to define the additional mechanism.

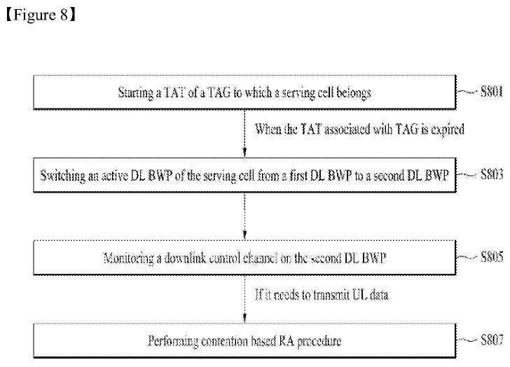

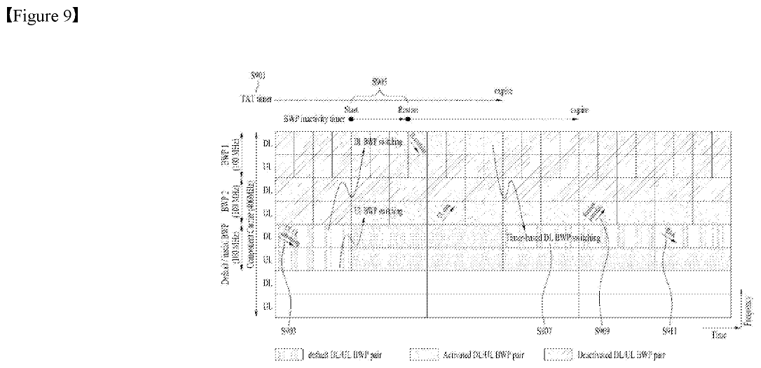

FIG. 8 is a conceptual diagram for performing a random access procedure in BWP operation by a user equipment in wireless communication system according to embodiments of the present invention.

This embodiment describes from a user equipment perspective.

According to the current NR, the UE can switch to the default BWP only by means of the BWP inactivity timer expiry or explicit downlink control information (DCI) signalling. This invention proposes an additional BWP switching condition based on the Time Alignment Timer in order for a UE to successfully perform the contention based RA procedure.

The assumption of this invention is as follows:
The initial BWP is defined as the bandwidth that all UEs can perform the initial access procedure regardless of UE capability. The initial active BWP is cell-commonly configured through the minimum system information.
The default BWP is defined as the bandwidth that the network explicitly configures to a UE in RRC-CONNECTED by RRC signaling. If no default DL BWP is configured to UE, the UE considers the initial active DL BWP as the default DL BWP. The default BWP is UE-specifically configured.
BWP switching does not impact the Time Alignment Timer.

The UE starts a first timer related to timing alignment of a Timing Advance Group (TAG) to which a serving cell belongs (S801).

Preferably, the first timer related to timing alignment of a TAG is a Time Alignment Timer (TAT) associated with pTAG.

Preferably, the TAT starts when a Timing Advance Command MAC control element (TAC MAC CE) is received, or a Timing Advance (TA) Command is received in a Random Access Response (RAR) message for a serving cell belonging to a TAG.

Preferably, the TAT is used to control how long the MAC entity considers the Serving Cells belonging to the associated TAG to be uplink time aligned. So, the UE considers that the UE is uplink synchronized while the TAT is running.

The UE switches an active Downlink (DL) Bandwidth Part (BWP) of the serving cell from a first DL BWP to a second DL BWP, when the TAT associated with TAG is expired (S803).

Preferably, the first DL BWP is currently an active DL BWP. Thus, while the first DL BWP is the currently active DL BWP, the BWP inactivity timer associated with the first DL BWP does not expire.

Preferably, the second DL BWP is default DL BWP or initial DL BWP.

So, this invention proposes that a UE switches/fallbacks to a default/initial BWP from an active BWP other than default/initial BWP, when the TAT is expired.

Preferably, the active DL BWP of the serving cell is switched from the first DL BWP to the second DL BWP, although a timer related to the first DL BWP of a serving cell is running, when the TAT expires. That is, the UE can switch to default BWP when the TAT is expired although the BWP inactivity timer doesn't expire.

Preferably, the timer related to the first DL BWP of a serving cell is a BWP inactivity timer. If a BWP other than default BWP is activated, the UE starts BWP inactivity timer. The BWP inactivity timer is restarted when the UE receives its DL assignment/scheduling on the BWP other than default BWP. If the BWP inactivity timer is expired, the UE fallbacks to its default BWP. This timer-based BWP switching is valid for the DL BWP, but if the DL and UL BWP is paired, both DL and UL BWP are switched to the default DL/UL BWP pair by the timer expiry.

Preferably, if the active DL/UL BWP has been paired (i.e. unpaired spectrum), a UE will switch to default DL/UL BWP pair when the switching condition is met. For unpaired spectrum, a DL BWP and an UL BWP are jointly configured as a pair, with the restriction that the DL and UL BWPs of such a DL/UL BWP pair share the same centre frequency but may be of different bandwidths in Rel-15 for each UE-specific serving cell for a UE. Based on the agreement, it seems that a DL BWP and an UL BWP can be jointly configured as a pair in the UE-specific manner for unpaired spectrum. Thus, when the UE switches an active DL BWP of the serving cell from a first DL BWP to a second DL BWP due to expiration of the TAT, the UE can switches an active UL BWP of the serving cell to a default/initial UL BWP.

Meanwhile, for paired spectrum, DL and UL BWPs are configured separately and independently in Rel-15 for each UE-specific serving cell for a UE. So, in this case where a DL BWP and a UL BWP are separately configured, when the UE switches to the initial DL BWP when TAT is expired, the UE can switch to initial UL BWP optionally. In this case, the active UL BWP is switched when a switching command for the active UL BWP is received regardless of the switching for the initial DL BWP.

Furthermore, when the TAT is expired, is switched when a switching command for the active UL BWP is received regardless of the switching for the initial DL BWP.

If the UE switches to the initial DL BWP only, the UE transmits a randomly selected preamble on the contention based RACH resource of the active UL BWP (S909).

The UE monitors downlink control channel on the initial DL BWP in order to receive the RAR message, which means the network should transmit the RAR message only on the initial DL BWP for all UEs (S911).

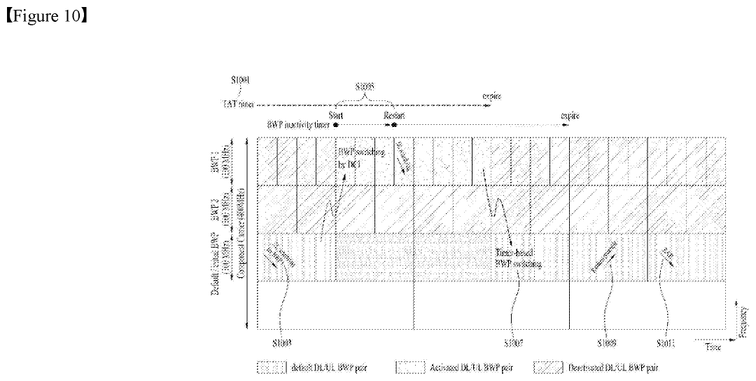

FIG. 10 shows a case DL/UL BWP are cell-commonly paired.

For unpaired spectrum, a DL BWP and an UL BWP are jointly configured as a pair in a cell-common manner. So, the different DL/UL BWP pair can be configured between UEs, but for a BWP pair, the DL BWP is always linkage to the certain UL BWP in the cell.

For example, the network can configure 3 DL/UL BWP pairs for a cell, i.e., pair 1, 2, 3, the network separately configures pair 1, 2 for UE1 and pair 2, 3 for UE2. Also, the default BWP can be set to pair 1 for UE1, and pair 2 for UE 2.

Here, UE1 may be supposed to perform the contention based RA procedure. If the network receives a random preamble on the contention based RA resources, the network can transmit RAR message on the DL BWP associated to the UL BWP which receives RA preamble. If there is no DL BWP switching for UE1 while performing the RA procedure, UE1 can successfully receive the RAR message on the associated DL BWP. However, if the BWP timer is expired while the UE performs CBRA procedure, the UE cannot receive the RAR message because of switching to the default DL BWP. The network may transmit the RAR on the DL BWP associated with the UL BWP because the network doesn't know which UE has transmitted the preamble. So, for cell-commonly paired DL/UL BWPs, this invention proposes that the UE performs the contention based RA procedure on the default/initial DL/UL BWP if TAT is expired.

The UE starts or restarts the Time Alignment Timer when the timer trigger condition is satisfied, such as receiving of a Timing Advance Command (S1001).

While TAT is running, if the UE needs to request any UL resources and it has the dedicated SR PUCCH, then the UE transmits SR on an active UL BWP and gNB will allocate the UL resource for the UE on an active DL BWP (S1003).

When the active DL BWP is switched to BWP 1, the BWP inactivity timer starts. When the UE receives DL scheduling information, the UE restarts the BWP inactivity timer (S1005).

If TAT is expired while the BWP inactivity timer is running, the UE switches to the default/initial DL/UL BWP and releases the PUCCH for all serving cells (S1007).

After TAT expiry, if the UE needs to request any UL resource, the UE transmits a randomly selected preamble on the contention based RACH resource of the default/initial UL BWP (S1009).

The UE monitors downlink control channel on the default/initial DL BWP in order to receive the RAR message, which means the network should transmit the RAR message only on the default/initial DL BWP for all UEs (S1011).

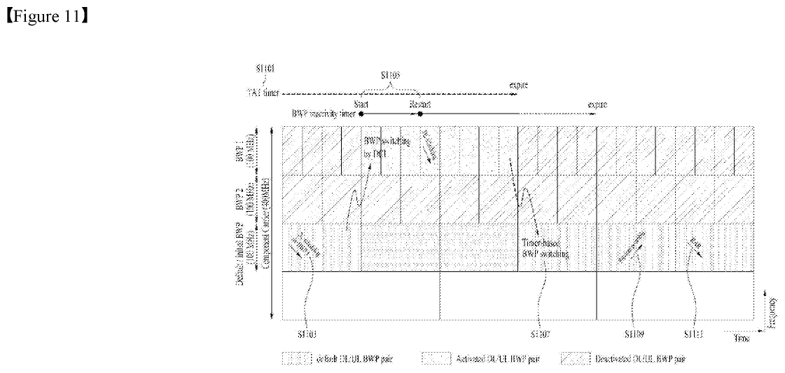

FIG. 11 shows a where DL/UL BWP is UE-specifically paired.

For unpaired spectrum, a DL BWP and an UL BWP are jointly configured as a pair. Unlike FIG. 10, the different DL/UL BWP pair can be configured separately between DL and UL as well as between UEs, which means the DL BWP is linkage to a certain UL BWP only for the specific UE.

For example, the network can configure 3 DL/UL BWP pairs for UE1 and the UE can dynamically switch between these BWP pairs by DL scheduling or UL scheduling received on the active DL BWP. On the other hand, for UE2, the network can configure 3 different DL/UL BWP pairs consisting of different DL and UL BWP pairing from UE1. In this case, if a UE may perform the CBRA procedure, the network doesn't know which UE has transmitted the preamble although the UE transmits the preamble on its default BWP, which means that the network cannot know BWP to send the RAR. So this invention proposes that the UE performs the contention based RA procedure on the initial DL/UL BWP pair if TAT is expired.

The UE starts or restarts the Time Alignment Timer when the timer trigger condition is satisfied, such as receiving of a Timing Advance Command (S1101).

While TAT is running, if the UE needs to request any UL resources and it has the dedicated SR PUCCH, then the UE transmits SR on an active UL BWP and network will allocate the UL resource for the UE on an active DL BWP (S1103).

When the active DL BWP is switched to BWP 1, the BWP inactivity timer starts. When the UE receives DL scheduling information, the UE restarts the BWP inactivity timer (S1105).

If TAT is expired while the BWP timer is running, the UE switches to the initial DL/UL BWP pair and releases the PUCCH for all serving cells (S1107).

After TAT expiry, if the UE needs to request any UL resource, the UE transmits a randomly selected preamble on the contention based RACH resource of the initial UL BWP (S1109).

The UE monitors downlink control channel on the initial DL BWP in order to receive the RAR message, which means the network should transmit the RAR message only on the initial DL BWP for all UEs (S1111).

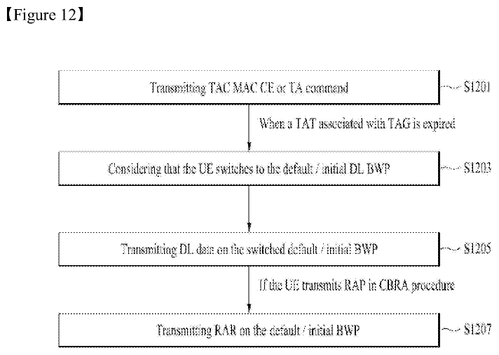

FIG. 12 is a conceptual diagram for performing a random access procedure in BWP operation by a base station in wireless communication system according to embodiments of the present invention.

This embodiment describes from a base station perspective.

The network transmits Timing Advance Command MAC control element (TAC MAC CE) or Timing Advance (TA) Command in a Random Access Response (RAR) message for a serving cell belonging to a TAG (S1201). The UE starts Time Alignment Timer (TAT) associated with pTAG (TAT) when the TAC MAC CE is received, or a TA Command is received in a RAR message for a serving cell belonging to the pTAG. While the TAT is running, the UE and the network consider that the UE is in uplink synchronized.

When the TAT associated with TAG is expired, the networks considers that the UE switches to the default/initial DL BWP (or default/initial DL/UL BWP pair) (S1203) and the networks transmits DL data on the switched default/initial BWP (S1205).

Meanwhile, after expiration of the TAT, the UE should perform the contention based RA procedure if the UE needs to transmit UL data (S1207).

More specifically, after the TAT expiry, if the UE needs to request any UL resource, the networks receives a randomly selected preamble on the contention based RACH resource of the active UL BWP. And the network transmits downlink control channel on the initial DL BWP in order to receive the RAR message, which means the network should transmit the RAR message only on the initial DL BWP for all UEs.

The proposed method is implemented by a network apparatus, shown in FIG. 6, but it can be any apparatus for performing the same operation.

As shown in FIG. 6, the network apparatus may comprises a processor (1111 or 1211), Memory (1112 or 1212), and RF module (transceiver; 1113 or 1213). The processor (1113 or 1213) is electrically connected with the transceiver (1113 or 1213) and controls it.

Specifically, FIG. 6 may represent a network apparatus comprising a processor (1111 or 1211) operably coupled with the RF module (transceiver; 1113 or 1213) and configured to transmit TAC MAC CE or TA Command in a RAR message for a serving cell belonging to a TAG, consider that DL BWP is switched to default DL BWP when the TAT is expired, and to transmit DL data on the switched default/initial BWP.

The transceiver 1113 or 1213 operably connected or coupled to the processor may receive a Random Access Preamble (RAP) on an active uplink (UL) BWP, and transmit Random Access Response (RAR) in response to the RAP on the second DL BWP.

The aforementioned implementations are achieved by combination of structural elements and features of the present disclosure in a predetermined manner. Each of the structural elements or features should be considered selectively unless specified separately. Each of the structural elements or features may be carried out without being combined with other structural elements or features. In addition, some structural elements and/or features may be combined with one another to constitute the implementations of the present disclosure. The order of operations described in the implementations of the present disclosure may be changed. Some structural elements or features of one implementation may be included in another implementation, or may be replaced with corresponding structural elements or features of another implementation. Moreover, it is apparent that some claims referring to specific claims may be combined with another claims referring to the other claims other than the specific claims to constitute the implementation or add new claims by amendment after the application is filed.

The above-described embodiments may be implemented by various means, for example, by hardware, firmware, software, or a combination thereof.

In a hardware configuration, the method according to the embodiments of the present invention may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, or microprocessors, etc.

In a firmware or software configuration, the method according to the embodiments of the present invention may be implemented in the form of modules, procedures, functions, etc. performing the above-described functions or operations. Software code may be stored in a memory unit and executed by a processor. The memory unit may be located at the interior or exterior of the processor and may transmit and receive data to and from the processor via various known means.

Those skilled in the art will appreciate that the present invention may be carried out in other specific ways than those set forth herein without departing from essential characteristics of the present invention. The above embodiments are therefore to be construed in all aspects as illustrative and not restrictive. The scope of the invention should be determined by the appended claims, not by the above description, and all changes coming within the meaning of the appended claims are intended to be embraced therein.

### INDUSTRIAL APPLICABILITY

While the above-described method has been described centering on an example applied to the 3GPP LTE and NR system, the present invention is applicable to a variety of wireless communication systems in addition to the 3GPP LTE and NR system.

1. A method for a communication device operating in a wireless communication system, the method comprising:
starting a timer related to timing alignment of a Timing Advance Group (TAG) to which a serving cell belongs;
switching an active Downlink (DL) Bandwidth Part (BWP) of the serving cell from a first DL BWP to a second DL BWP, when the timer expires; and
monitoring a downlink control channel on the second DL BWP.

2. The method according to claim 1, further comprising:
transmitting a Random Access Preamble (RAP) on an active uplink (UL) BWP; and
monitoring Random Access Response (RAR) in response to the RAP on the second DL BWP.

3. The method according to claim 2, wherein the RAP is transmitted based on Contention-Based Random Access (CBRA) procedure.

4. The method according to claim 1, wherein the active DL BWP of the serving cell is switched from the first DL BWP to the second DL BWP, although a timer related to the first DL BWP of a serving cell is running, when the timer expires,
wherein the timer related to the first DL BWP of the serving cell is started when the first DL BWP is activated.

5. The method according to claim 1, wherein the active UL BWP is switched to a default UL BWP or an initial UL BWP when the active DL BWP is switched from the first DL BWP to the second DL BWP.

6. The method according to claim 1, wherein the second DL BWP is a default DL BWP or an initial DL BWP.

7. The method according to claim 1, when the timer expires, Physical Uplink Control Channel (PUCCH) resources for all serving cells belonging to the TAG are released.

8. A communication device for operating in a wireless communication system, the communication device comprising:
a memory; and
a processor operably coupled with the memory module and configured to:
start a timer related to timing alignment of a Timing Advance Group (TAG) to which a serving cell belongs;
switch an active Downlink (DL) Bandwidth Part (BWP) of the serving cell from a first DL BWP to a second DL BWP, when the timer expires; and
monitor a downlink control channel on the second DL BWP.

9. The communication device according to claim 8, wherein the processor is further configured to transmit a Random Access Preamble (RAP) on an active uplink (UL) BWP, and to monitor Random Access Response (RAR) in response to the RAP on the second DL BWP.

10. The communication device according to claim 9, wherein the RAP is transmitted based on Contention-Based Random Access (CBRA) procedure.

11. The communication device according to claim 8, wherein the active DL BWP of the serving cell is switched from the first DL BWP to the second DL BWP, although a timer related to the first DL BWP of a serving cell is running, when the timer expires, wherein the timer related to the first DL BWP of the serving cell is started when the first DL BWP is activated.

12. The communication device according to claim 8, wherein the active UL BWP is switched to a default UL BWP or an initial UL BWP when the active DL BWP is switched from the first DL BWP to the second DL BWP.

13. The communication device according to claim 8, wherein the second DL BWP is a default DL BWP or an initial DL BWP.

14. The communication device according to claim 8, when the timer expires, Physical Uplink Control Channel (PUCCH) resources for all serving cells belonging to the TAG are released.

15. The communication device according to claim 8, wherein the communication device is capable of communicating with at least one of another device, a device related to an autonomous driving vehicle, a base station or a network.
